(19) United States
(12) Patent Application Publication
(10) Pub. No.: US 2013/0025564 A1
(43) Pub. Date: Jan. 31, 2013

(54) OIL SEPARATOR FOR CRANKCASE VENTILATION

(71) Applicant: DEDI SETIADI, LISLE, IL (US)

(72) Inventor: DEDI SETIADI, LISLE, IL (US)

(73) Assignee: ELECTRO-MOTIVE DIESEL, INC., LAGRANGE, IL (US)

(21) Appl. No.: 13/193,383

(22) Filed: Jul. 28, 2011

(51) Int. Cl. F02M 35/024; B01D 50/00

(52) U.S. Cl. 123/198 E; 55/385.3; 95/287

(57) ABSTRACT

A two-stage oil separator for crankcase ventilation includes a housing having a lower end and an upper end. The lower end communicates with the crankcase and the upper end communicates with an exhaust system. The housing defines an internal flow channel extending generally upwards from the lower end toward the upper end. A first-stage filter element is disposed proximate the lower end and includes a first filter media of relatively coarser porosity. A second-stage filter element is disposed proximate the upper end and vertically upward of the first-stage filter element. The second-stage filter element includes a second filter media of relatively finer porosity than the first filter media.

### TECHNICAL FIELD

This patent disclosure relates generally to oil separators for removing oil and/or particulate matter from gasses discharged from an internal combustion engine, and more particularly to oil separators utilized in a crankcase ventilation system for discharging gasses from an engine crankcase.

### BACKGROUND

Internal combustion engines are widely used to convert a combustible fuel into rotational motion that in turn can be used for mechanical work such as powering or propelling machinery. For example, diesel locomotive engines combust diesel fuel to rotate a crankshaft that propels the locomotive. The crankshaft is generally disposed in a crankcase underneath the engine block and below the cylinders in which combustion takes place. Present in the crankcase may be oil vapor or other lubricants and additionally blow-by gasses, i.e., gasses that inadvertently pass by the piston rings and down the combustion cylinders, gasses that pass through a pressurized intake manifold, gasses that bypass the turbo seals, gasses that bypass valve guide seals, etc, may accumulate there. Typically, it is desirable to remove the gasses and other particulate matter accumulating in the crankcase and maintain the crankcase at a slightly negative pressure, for example, in order to prevent an unintended explosion of combustible gasses in the crankcase or over-pressurization of the crankcase that may blowout gaskets or seals and result in leakage of fluids. To accomplish this, a negative crankcase ventilation system may be utilized.

U.S. Pat. No. 6,647,973 (“the '973 patent”), for example, describes a ventilation system that removes blow-by gasses and other gasses and oil vapor from the crankcase of a diesel engine and directs them to the exhaust system and eventually to the atmosphere. For environmental protection and to reduce soot and other harmful emissions, the '973 patent describes a two-stage filtration assembly that can remove oil vapor and particulate matter from the crankcase gasses. The first-stage includes a first-stage chamber that directly interfaces with the crankcase and a second-stage that includes a separate second-stage chamber adjacently disposed next to the first-stage chamber. As described in the '973 patent, the second-stage chamber is mounted at an angle of about 20° relative to the horizontal so that separated oil collecting at the bottom of the second-stage chamber may drain to a passageway located at the bottom-most point of the first-stage chamber and back to the crankcase. Configurations such as the foregoing for removing separated oil and/or particulate matter from the filtration assembly are desirable because, if separated oil and other particles accumulate in the filtration assembly, they may clog the assembly or they may suddenly discharge through the exhaust system and into the environment. Additionally, configuring the filtration assembly to remove and return oil and/or particulate matter to the crankcase may help prolong the functional life of the crankcase filter elements.

### SUMMARY

The disclosure describes, in one aspect, a two-stage oil separator for ventilating gasses from a crankcase of an internal combustion engine. The two-stage oil separator can include a housing having a lower end and an upper end. The lower end of the housing communicates with the crankcase and the upper end communicates with the exhaust system of the internal combustion engine. The housing also defines an internal flow channel extending generally upwards from the lower end toward the upper end. A first-stage filter element is disposed in the flow channel toward or in the lower end. The first-stage filter element includes a first filter media of a relatively coarse porosity. A second-stage filter element is disposed toward or in the upper end and generally upward of the first-stage filter element and includes a second filter media of relatively finer porosity.

In a further aspect, there is disclosed a method of ventilating gasses from a crankcase that in part provides a housing including a lower end and an upper end. The lower end communicates with the crankcase and the upper end communicates with an exhaust system. The housing thereby defines at least in part a generally upward flow channel. The method includes directing the crankcase gasses to a first stage filter element disposed toward or in the lower end of the housing and separating from the crankcase gasses relatively larger droplets of oil and or particulate matter. The method further includes directing the crankcase gasses generally upwards through the generally upward flow channel to a second stage filter element disposed toward or in the upper end of the housing and filtering from the crankcase gasses relatively smaller oil droplets and/or particulate matter.

In yet another aspect, the disclosure describes an internal combustion engine having a crankcase with a rotating crankshaft disposed therein. The crankshaft defines a horizontal axis of rotation. The internal combustion engine includes a first two-stage oil separator having a generally upright housing communicating with the crankcase via a lower end and communicating with an exhaust system of the internal combustion engine via an upper end. The first two-stage oil separator further includes a first-stage filter element disposed toward or in the lower end and a second-stage filter element disposed toward or in the upper end vertically above the first-stage filter element. The internal combustion engine also includes a second two-stage oil separator having a generally upright housing communicating with the crankcase via a lower end and communicating with the exhaust system via an upper end. Like the first two-stage oil separator, the second two-stage oil separator also includes a first-stage filter element disposed toward or in the lower end and a second-stage filter element disposed toward or in the upper end vertically above the first-stage filter element. Further, the first and second two-stage oil separators are radially offset from each other with respect to the horizontal axis of rotation.

### BRIEF DESCRIPTION OF THE DRAWING(S)

FIG. 1 is a perspective view of a portion of an internal combustion engine such as a diesel engine including a turbo and a crankcase ventilation system having first and second two-stage oil separators.

FIG. 2 is a perspective view of the two-stage oil separator detached from the diesel engine.

FIG. 3 is a cross-sectional view of the two-stage oil separator defining an upward flow channel and including therein the first-stage filter element and the vertically aligned second-stage filter element, as taken along line 3-3 of FIG. 2.

FIG. 4 is a perspective assembly view of the first-stage filter element including a shell for accommodating the first filter media.

FIG. 5 is a perspective view of the second-stage filter element including a second filter media disposed about a steel rod frame.

FIG. 6 is a front plane view of another embodiment of a crankcase ventilation system utilizing a single two-stage oil separator.

FIG. 7 is a bar chart comparing removal of particulate matter from the exhaust of a diesel engine equipped with various types of oil separators.

### DETAILED DESCRIPTION

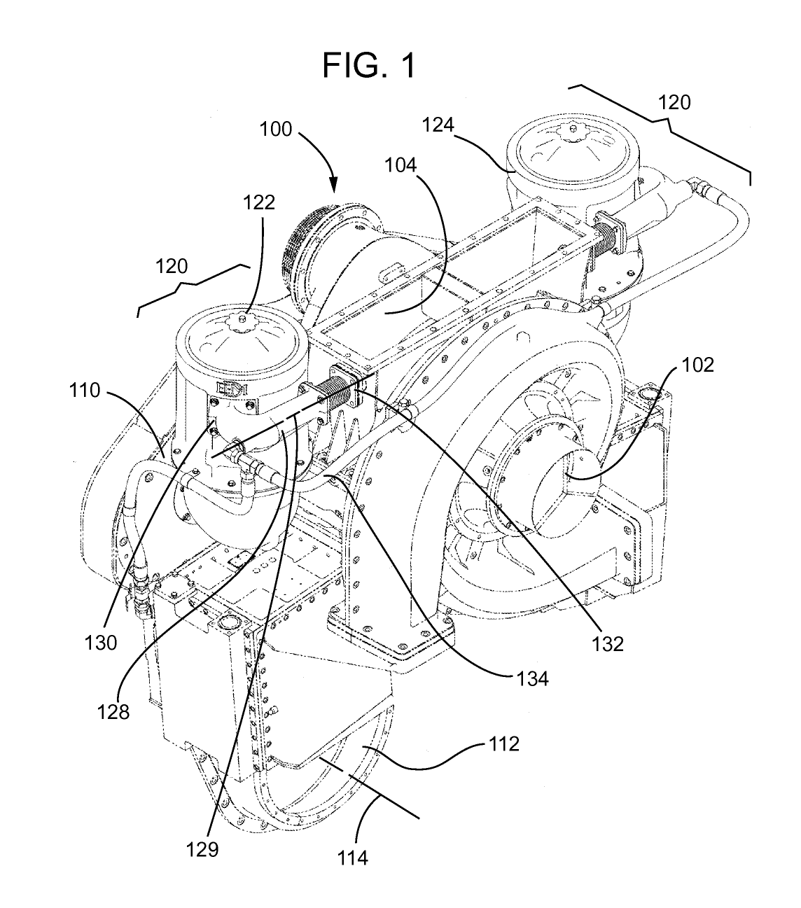

This disclosure relates to a crankcase ventilation system for removing gasses from the crankcase of an internal combustion engine such as a diesel locomotive engine. However, the ventilation system may be utilized in other applications such as with engines that combust other types of fuel or are used for other purposes such as generation of electricity or powering machinery. Referring to FIG. 1, the illustrated internal combustion engine 100 may include at its forefront a turbo 102 for compressing intake air by use of an exhaust driven turbine, as will be appreciated by those of skill in the art. Hence, the turbo 102 may include or communicate with a portion of the exhaust manifold or an exhaust duct 104 through which pass the exhaust gasses from the combustion process. In the embodiment illustrated in FIG. 1, the turbo 102 is disposed forward of and adjacent to at least a portion of the crankcase 110 which accommodates the crankshaft in a lower crankshaft bearing 112 and which thereby defines a crankshaft axis line 114. The crankcase 110 may also include the oil pan and may receive other fluids or gasses such as blow-by gasses from leak sources described above. As described above, the oil may vaporize and accumulate in the crankcase along with the blow-by gasses. To remove these crankcase gasses and direct them to the exhaust duct 104, a crankcase ventilation system 120 is included with the internal combustion engine 100.

In the embodiment illustrated in FIG. 1, the crankcase ventilation system 120 includes a first two-stage oil separator 122 and a second two-stage oil separator 124 and can therefore be referred to as a dual separator embodiment, although other embodiments are described hereinafter. In the dual separator embodiment, the first two-stage oil separator 122 is disposed on one side of the internal combustion engine 100 and the second two-stage oil separator 124 is disposed on the opposite side. Hence, the first and second two-stage oil separators 122, 124 are radially offset from each other with respect to the crankshaft axis line 114. In other embodiments, though, the first and second two-stage oil separators can be arranged in other locations about the internal combustion engine. The first and second two-stage oil separators 122, 124 are generally identical and are arranged in mirror fashion on the internal combustion engine 100. Thus, the first two-stage oil separator 122 will be described in further detail, and such description will generally apply to the second two-stage oil separator 124.

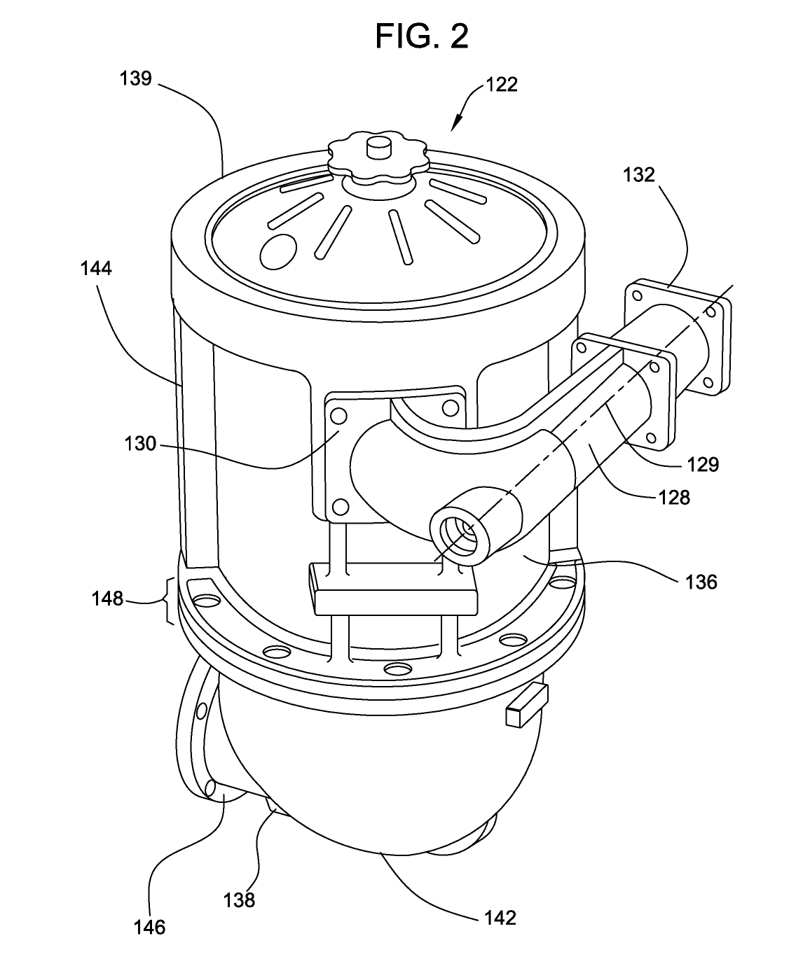

The first two-stage oil separator 122 communicates with the crankcase 110 to receive crankcase gasses and can direct those gasses onto the exhaust duct 104. To drive or draw the crankcase gasses through the first two-stage oil separator to the exhaust duct 104, an ejector 128 connects the separator and the exhaust duct. The J-shaped ejector 128, which may take the form of an eductor, an aspirator, a Venturi tube or the like, is attached to the first two-stage oil separator 122 via an ejector port 130 and also attaches to the exhaust duct 104 via a flexible exhaust port 132. As will be appreciated by those of skill in the art, the ejector 128 includes internal nozzles so that a high-pressure motive fluid introduced at one end of the ejector can expand internally and generate an internal vacuum such as by generating a Venturi effect that draws crankcase gasses into the ejector through the ejector port 130. Motive fluid and the crankcase gasses can discharge from the ejector 128 to the exhaust duct 104 via the exhaust port 132. The motive fluid can be cooled turbo-charged air diverted from the turbo 102 by an ejector line 134. In the illustrated embodiment depicted in FIGS. 1 and 2, the ejector line 134 connects to the J-shaped ejector 128 so as to be axially aligned with respect to the exhaust port 132 along a straight ejector axis 129 so that the incoming motive fluid has an unobstructed discharge path to the exhaust duct 104. Although in the illustrated embodiment, the ejector 128 is external of the first two-stage oil separator, in other embodiments the ejector can be disposed inside of or through the separator.

Referring to FIG. 2, the two-stage oil separator 122 includes a generally upright housing 136 that extends between a lower end 138 and an upper end 139. The two-stage oil separator 122 can be installed so that the lower end 138 of the housing is directed downwards and the upper end 139 is directed upwards thus providing the upright orientation. In the illustrated embodiment, the housing 136 may be formed in two parts including a lower elbow portion 142 associated with the lower end 138 and an upper upright portion 144 associated with the upper end 139. Of course, in other embodiments, the housing 136 may be cast as a single piece or may be formed as a plurality of pieces. The housing 136 can be made from any suitable material including, for example, machined cast aluminum. The lower elbow portion 142 is shaped as an elbow and has a crankcase flange 146 at its distal end for mounting to the crankcase. The upright portion 144 is an upright, cylindrical structure that mounts to the top of the lower elbow portion 142. The elbow portion 142 and the upright portion 144 may include complementary, mating flanges 148 that can be bolted together to facilitate joinder of the elbow portion and the upright portion.

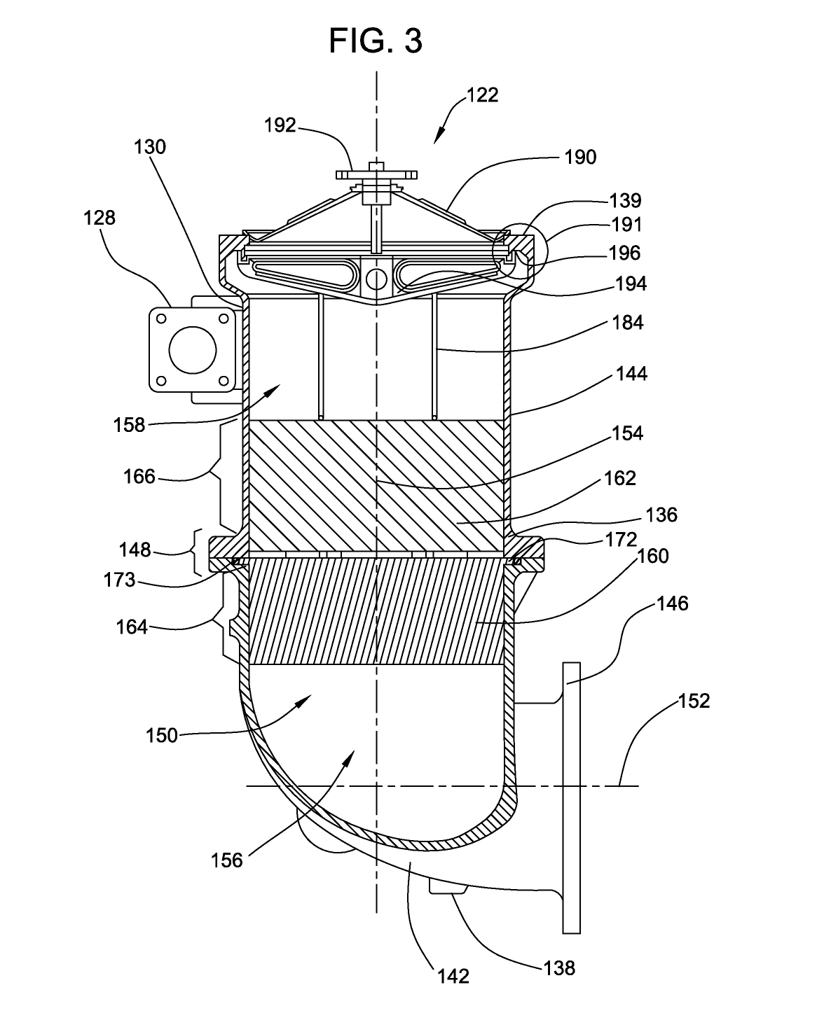

Referring to FIG. 3, the housing 136 is hollow and defines an internal flow channel 150 for directing the crankcase gasses to the exhaust system. In particular, the internal flow channel 150 has a generally upward direction with respect to a horizontal reference line 152. Initially, the crankcase gasses can enter the lower elbow portion 142 of the housing from the crankcase in a horizontal direction along the horizontal reference line 152. The bend of the elbow portion 142 redirects the horizontally incoming crankcase gasses upwards to a lower vertical region 156 of the flow channel 150. The upright portion 144 defines an upper vertical region 158 of the flow channel 150 that continues to direct the crankcase gasses vertically upwards along a vertical reference line 154 that is substantially perpendicular to the horizontal reference line 152. The lower vertical region 156 and the upper vertical region 158 can have roughly the same cross-sectional dimensions so that the crankcase gasses may be directed along the flow channel 150 under uniform flow distribution. In an embodiment, the cross-sections of the lower vertical region 156 and upper vertical region 158 may be generally circular or cylindrical in shape to promote gas flow. To draw or pull the crankcase gasses upwards through the flow channel 150, the ejector 128 and the ejector port 130 are disposed at the upper end of the upright portion 144.

To separate out oil and particulate matter entrained in the crankcase gasses, the two-stage oil separator 122 includes a lower first-stage filter element 160 and an upper second-stage filter element 162. The first-stage filter element 160 is disposed inside the lower elbow portion 142 toward or within the lower vertical region 156 of the flow channel 150 and thus proximate to the lower end 138 of the housing 136. The incoming crankcase gasses therefore have already been directed upwards when they encounter the first-stage filter element 160. As will be described in further detail herein, the first-stage filter element 160 includes a first filter media 164 of relatively coarser porosity to separate out larger oil droplets and particulate matter from the crankcase gasses. For example, the first filter media 164 can be particularly suited to remove larger oil droplets and particulate matter on the order of 5 microns or larger while allowing smaller droplets and particles to pass through. The gasses enter the bottom of the first-stage filter element 160, undergo separation, exit through the top and are directed toward the upper vertical region 158 of the flow channel 150.

The second-stage filter element 162 is disposed in the upright portion 144 toward or within the upper vertical region 158 of the flow channel 150 and thus proximate the upper end 139 of the housing 136. The second-stage filter element is therefore downstream of the first-stage filter element 160 to receive the upwardly directed, first-stage filtered crankcase gasses. The second-stage filter element 162 includes a second filter media 166 that is relatively finer than the first filter media 164 and can filter smaller oil droplets and particulate matter. For example, the second filter media 166 can be adapted to remove droplets and particles on the order of 1 micron or larger. After passing through the second-stage filter element 162, the filtered and cleaned crankcase gasses exit the two-stage oil separator 122 via the ejector 128 that can direct the crankcase gasses onto the exhaust duct.

The first-stage filter element 160 and the second-stage filter element 162 are vertically aligned along the vertical reference line 154 such that the second-stage filter element is located vertically above the first-stage filter element. The first-stage filter element 160 can be slightly spaced below the second-stage filter element 162 by, for example, two or three inches though in other embodiments they can physically contact each other. Hence, the first-stage filter element 160 and the second-stage filter element 162 may appear in a vertically stacked relationship. Additionally, the incoming crankcase gasses must rise vertically upwards along the vertical reference line 154 to proceed from the first-stage filter element 160 to the second-stage filter element 162.

The vertical arrangement and relationship of the first-stage filter element 160 and second-stage filter element 162 is believed to help promote separation of oil and/or particulate matter from the crankcase gasses and overall improves emissions from the exhaust system. In particular, the first-stage filter element and the second-stage filter element and the relative porosity of the first and second filter medias cooperate to improve separation of oil and/or particulate matter from the crankcase gasses and return that matter to the crankcase. Filtration through the two-stage oil separator proceeds in stages from separation of larger droplets and particles to filtration of smaller droplets and particles. This tends to ensure that the appropriate filter media filters the appropriate droplets and particular matter and further that the first and second filter medias cooperate together to increase efficiency. For example, as the filtered oil droplets gathers on the finer porosity second filter media 166, they will coalesce together forming larger, heavier droplets until gravity causes them to fall to the first-stage filter element 160. Those droplets will encounter the larger, separated oil droplets that have accumulated in the coarser porosity first filter media 164 and will coalesce together. Gravity will cause these droplets to fall into the lower vertical region 156 of the flow channel 150. The vertically falling oil droplets may encounter and coalesce with oil vapor entrained in the incoming crankcase gasses further advancing the separation process. The droplets impinge upon the bottom, interior surface of the lower elbow portion 142 which will channel the liquid oil to the crankcase. Additionally, because the flow channel 150 is generally sized to have a generally similar diameter or cross-section from the lower vertical region 156 through the elbow portion 142 to the crankcase flange 146, i.e., the flow channel through these regions is generally proportional, separated oil is less likely to become trapped or otherwise impeded from returning to the crankcase.

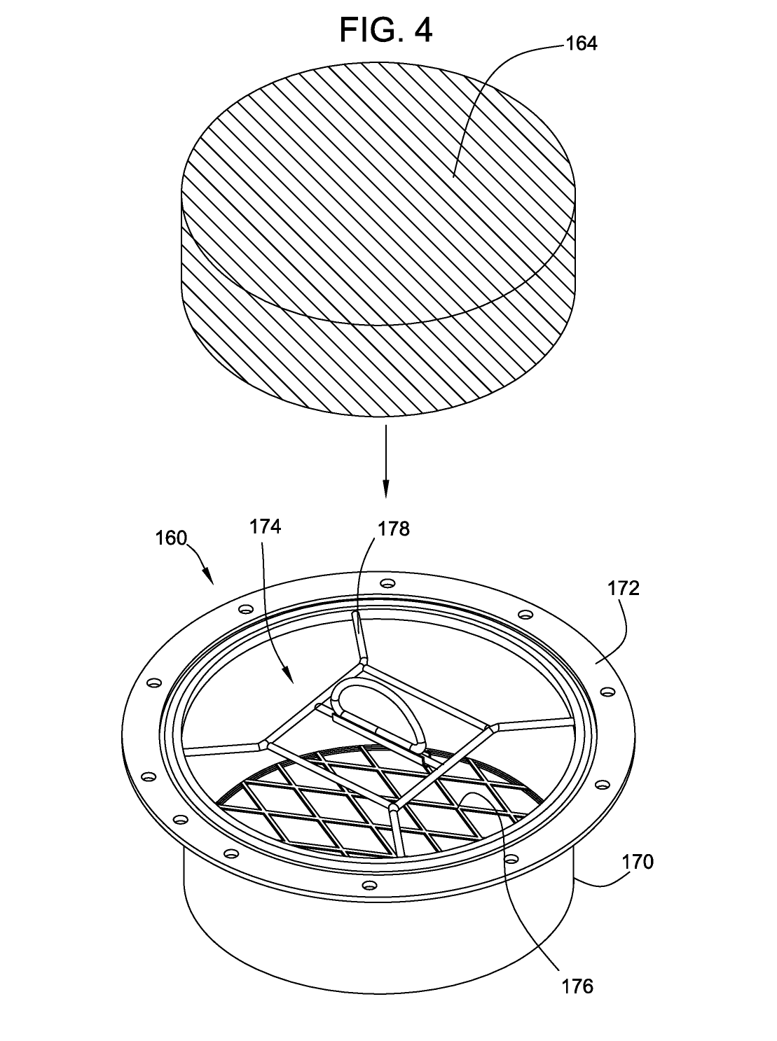

Referring to FIG. 4, there is illustrated an embodiment of the first-stage filter element 160 with the first filter media removed. The first-stage filter element 160 has a circular puck-like shape and includes an outer shell 170 and a protruding flange 172 that extends around an upper edge of the outer shell. Referring to FIG. 3, when the first-stage filter element 160 is installed in the housing 136, the flange 172 can be clamped between the mating flanges 148 of the lower elbow portion 142 and the upper upright portion 144 with the clamped flanges sealed by one or more suitably positioned o-rings 173. When clamped in place, the first-stage filter element 160 is suspended within the flow channel 150 and generally disposed in the lower vertical region 156 and toward the lower end 138 of the housing 136. Referring back to FIG. 4, the first filter media 164 can be placed inside and accommodated by a correspondingly sized and shaped internal bore 174 defined by the outer shell 170. To enable the crankcase gasses to access the first filter media, the bottom surface of the outer shell 170 can be formed as a screen 176 which allows the gasses to pass therethrough. Likewise, to allow the crankcase gasses to exit the top of the first-stage filter element 160, a lid 178 made from interconnected bars or struts that provide a substantial amount of open area can be attached to the top of the outer shell 170 by, for example, welding. In another embodiment, rather than welding the lid 178 to outer shell 170, the lid can be removed to access the internal bore 174 so that the first filter media can be inserted into the outer shell and, if necessary, periodically removed and replaced or cleaned.

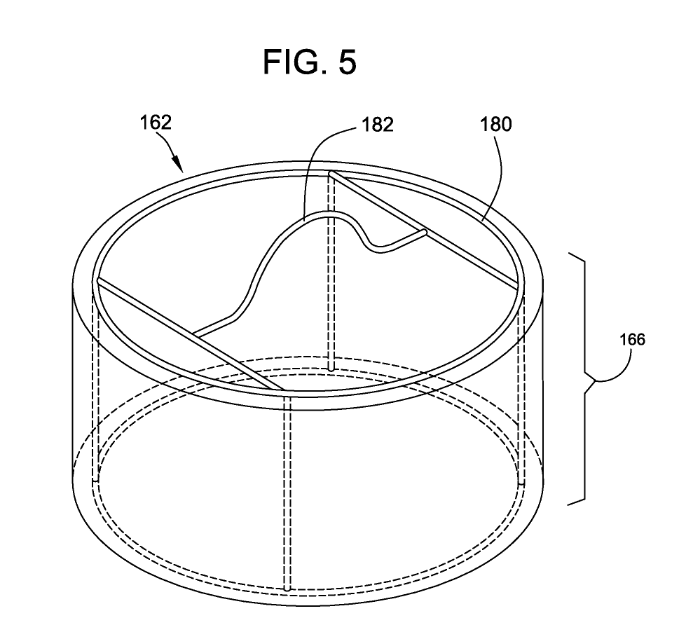

Referring to FIG. 5, there is illustrated an embodiment of the second-stage filter element 162 which can also have a generally circular, puck-like shape. The cross-sectional dimension of the second-stage filter element 162 can be roughly the same as the first-stage filter element 160 so that the two have the generally same cross-sectional area to receive the incoming crankcase gasses. The second-stage filter element 162 can include a steel rod frame 180 that is encapsulated in and supports the second filter media 166. Referring back to FIG. 3, the second-stage filter element 162 can be inserted into the upright portion 144 so as to be positioned generally within the upper vertical region 158 of the flow channel 150 and toward the upper end 139 of the housing 136.

To maintain its position, the second-stage filter element 162 can be designed slightly larger in diameter than the upper vertical portion 158 so that it can form an interference fit within the flow channel 150. For example, the porous second filter media 166 can surround the steel rod frame 180 and can yield or be physically displaced when inserted into the upright portion 144 of the housing 136. To assist in inserting and removing the second-stage filter element from the upper vertical region 158, the steel rod frame 180 can also include a handle 182 that allows the second-stage filter element to be pulled from the upright portion 144 of the housing 136. Referring back to FIG. 3, to prevent the second stage filter element 162 from being blown upwards by the incoming crankcase gasses, a wire retainer 184 can be included that engages the internal walls of the upright portion 144 and urges down on the second-stage filter element.

As mentioned above, the first filter media can have a relatively coarser porosity than the second filter media. For example, the first filter media can be made from wire mesh or knitted wire mesh such as 304 stainless steel wire mesh with a coiled construction and which is well suited for separating out the larger oil droplets and/or particulate matter. The density of the first filter media can be on the order of about nine pounds per cubic foot. The second filter element can be made from a combined or co-knit metal wire and fiberglass mesh, such as a 304 stainless steel mesh co-knitted with fiberglass. These materials are found to be well-suited for filtering the smaller oil droplets and/or particulate matter that passes through the first filter media. The second filter media can have a density of about 12 pounds per cubic foot.

Referring to FIG. 3, to access the second-stage filter element when, for example, replacing or cleaning them, a conical-shaped cover 190 can be disposed on the top of the upper upright portion 144 of the housing. The cover 190 can be roughly the same diameter as the upright portion 144 and can include a latch mechanism 191 for releasably securing the cover to the housing 136. In particular, the cover 190 can include an external rotatably handle 192 that is threaded to a crossbar 194 that normally sits within the upper vertical region 158 of the housing 136. In the normal position, the tips of the crossbar 194 may extend underneath and engage with an overhanging lip structure 196 formed around the top edge of the upright portion 144. As the handle 192 is rotated, the crossbar 194 can extend or drop down into the upper vertical region 158 of the housing 136 away from the cover 190 thereby releasing the crossbar from under the lip structure 196. Afterwards, the cover 190 can be tilted or manipulated to remove the cover and the lowered crossbar 194 from the top of the upright portion 144 of the housing 136. After the second-stage filter element has been replaced or cleaned, the cover 190 can be placed back on top of the upright portion 144 and the handle 192 can be rotated again to draw the crossbar 194 upwards and re-engage the tips of the crossbar with the lip structure 196.

An advantage of using a cover 190 with a releasable latch mechanism 191 is that the second-stage filter element 162 and, if necessary, the first stage filter element 160 can be accessed without having to detach the upright portion 144 of the housing 136 from the elbow portion 142 of the housing. It is believed that the second-stage filter element 162 using the co-knit stainless steel and fiberglass mesh will require replacement and/or cleaning more frequently than the first-stage filter element in part because the finer porosity of the second filter media may become saturated more quickly than the first filter media. Accordingly, locating the second-stage filter element above the first-stage filter element and closer towards the cover facilitates servicing of the two-stage oil separator.

Using a first two-stage oil separator 122 and a second two-stage oil separator 124 as depicted in FIG. 1 is desirable when the internal combustion engine is of such a size that a substantial amount of filter media must be included to adequately separate out oil and/or particulate material from the crankcase gasses. For example, the combined capacity of the first and second two-stage oil separators enables the crankcase gasses to proceed at a lower velocity through the oil separators prolonging filtration. However, in other applications, the internal combustion engine may be small enough that only a single oil separator is necessary with the crankcase ventilation system.

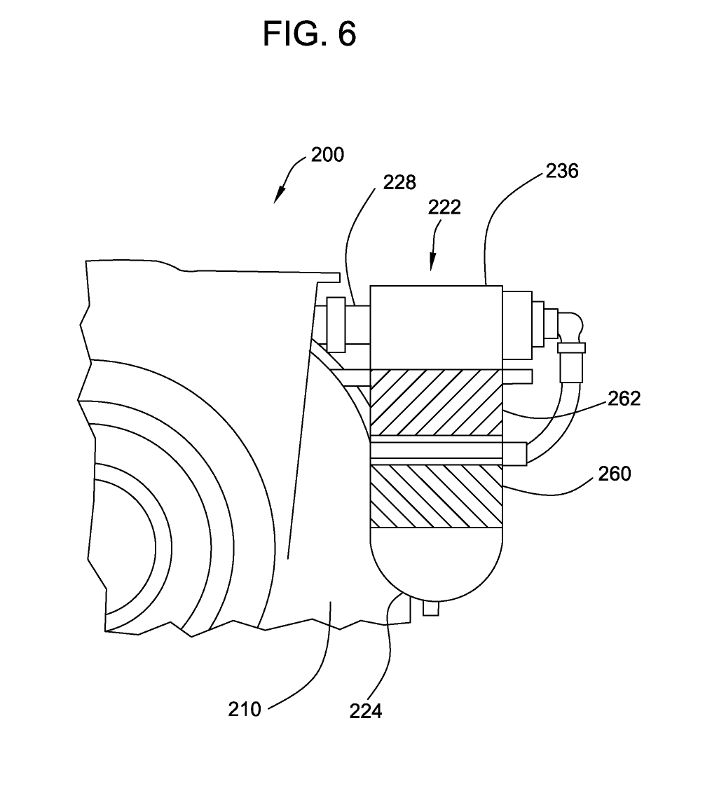

For example, referring to FIG. 6, there is illustrated another embodiment of an internal combustion engine 200 with a crankcase ventilation system 220 having a single two-stage oil separator 222. The single two-stage oil separator 222 can be mounted to the forefront of the internal combustion engine 200 and can communicate with the crankcase 210 by a crankcase pipeline 224 that attaches proximate to the bottom of the two-stage oil separator. An exhaust pipeline 228 can attach to the top of the separator and communicate with an exhaust system of the internal combustion engine for delivering the crankcase gasses to the exhaust system. The two-stage oil separator 222 again has a generally upright housing 236 and can be designed similar to the embodiment described with respect to FIGS. 2 and 3 in that the two-stage oil separator can include a first-stage filter element 260 and a vertically aligned second-stage filter element 262 positioned over the first-stage filter element. The two-stage oil separator 222 directs the incoming crankcase gasses upwards sequentially through the first-stage filter element 260 and the second-stage filter element 262 to perform the same two-stage filtration of the crankcase gasses before they are discharged to the exhaust system. The separated oil and/or particulate matter can be returned to the crankcase 210 via the crankcase pipeline 224.

### INDUSTRIAL APPLICABILITY

The present disclosure is applicable to a ventilation system for removing crankcase gasses from the crankcase of an internal combustion engine such as a diesel locomotive engine. Referring back to FIG. 1, when the internal combustion engine 100 is operating, charged motive fluid from the turbo 102 can be directed to the ejector 128 that is attached to the top of a two-stage oil separator 122. The ejector 128 creates a negative pressure in the top of the two-stage oil separator 122 which draws crankcase gasses from the crankcase 110 upwards through the oil-separator. Referring to FIG. 3, inside the two-stage oil separator, the crankcase gasses are directed upwards by the flow channel 150 to encounter a first-stage filter element 160 of relatively coarse porosity. The first-stage filter element 160 separates out larger oil droplets and/or particulate matter from the crankcase gasses that are then directed to a second-stage filter element 162 vertically positioned over the first-stage filter element 160. The second-stage filter element 162 filters out smaller oil droplets and/or particulate matter that, as the oil and particulate matter coalesce together, fall back through the first-stage filter element 160 under the influence of gravity and are returned to the crankcase.

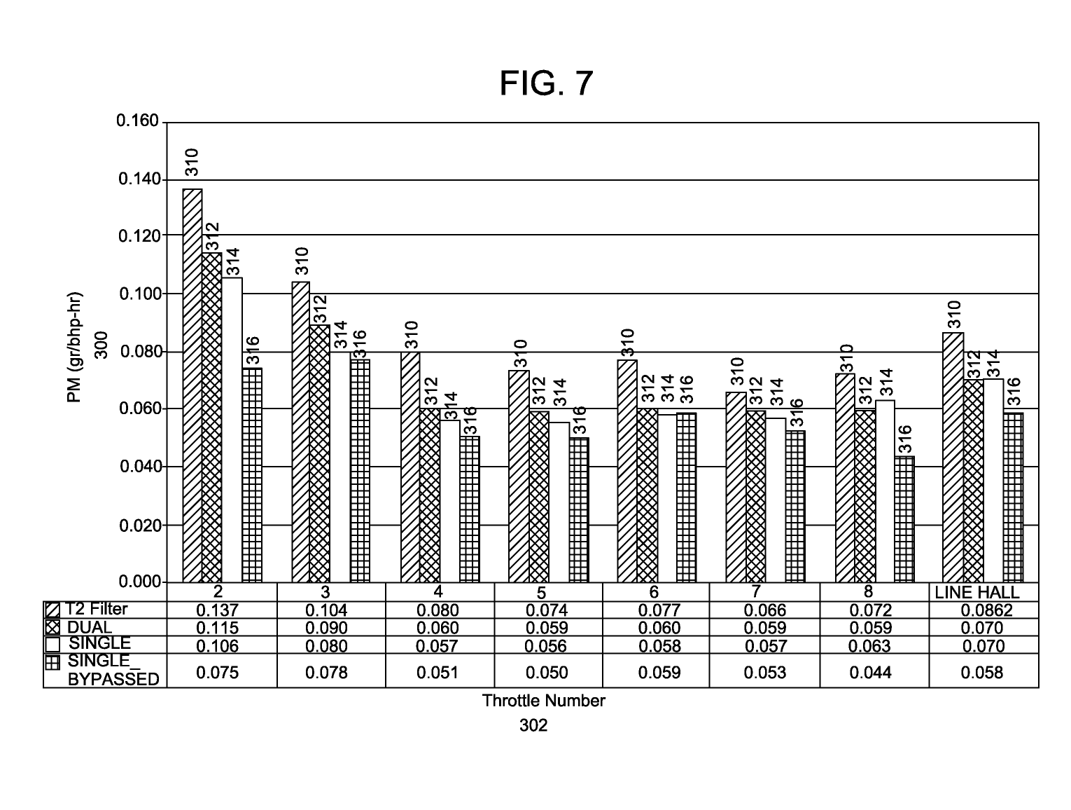

By utilizing a two-stage oil separator including the vertically arranged first-stage filter element and second-stage filter element, improvements in the separation of oil and/or particulate matter from the crankcase gasses can be realized. For example, referring to FIG. 7, there is a bar chart graphically illustrating data representing the removal of particulate matter for various throttle levels of a diesel engine for the two-stage oil separator as compared with a prior art single-stage oil separator. In particular, a diesel engine was operated and a portion of the gasses from the exhaust system, including crankcase gasses that passed through the oil separators and were directed into the exhaust system, were diverted to an analyzer that measured the particulate matter suspended in the gasses. Hence, a comparison was obtained that showed by quantity or weight how much particulate matter remained in the crankcase gasses after they had been directed through different oil-separators.

The Y-axis 300 in FIG. 7 represents the rate of particulate matter in grams per brake horsepower hour or (gr/bhp−hr). The X-axis 302 represents various throttle levels or throttle numbers of the diesel engine where measurements were taken, which may correspond to the predetermined throttle levels that many locomotive diesel engines have for speed control and coordination between several engines that may be coupled together. The bars at the right of the chart corresponding to “Line Haul may represent an average over selected throttle notches. For each throttle level, the first bar 310 from the left for each throttle level represents the particulate matter that was measured for the diesel engine using a prior art, single-stage oil separator. The second bar 312 from the left represents the particulate matter measured for the diesel engine using the first and second two-stage oil separator, or dual separator embodiment similar to that depicted in FIG. 1. The third bar 314 represents the particulate matter measured for the engine using a single two-stage oil separator similar to that depicted in FIG. 6. For the measurements for the fourth bar 316, the crankcase gasses were diverted away from the exhaust system and hence not part of the analysis. Thus, the fourth bar 316 represents only exhaust gasses from the combustion process absent any crankcase gasses and thus represents a diesel engine in which no bypass gasses or oil vapor is removed from the crankcase, i.e., a clean crankcase.

As can be appreciated from FIG. 7, the second bar 312 and the third bar 314 for the two-stage oil separators show a reduction in the level of particulate matter present in the exhaust gasses as compared to the first bar 310 for the single-stage separator. Assuming that the composition of the exhaust gasses from combustion alone was generally the same for each testing run, the two-stage oil separators for both the dual separator and single separator embodiments had a better removal rate of particulate matter from the crankcase gasses than the single-stage embodiment. Hence, the two-stage embodiments are more efficient and will produce cleaner exhaust gasses. Additionally, the chart in FIG. 7 illustrates that the two-stage oil separators remove more particulate matter than the single-stage oil separators at each throttle level and hence help reduce emissions across the full range of throttle levels for the diesel engine.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A two-stage oil separator for crankcase ventilation comprising:
a housing including a lower end and an upper end, the lower end in communication with the crankcase, the upper end in communication with an exhaust system, the housing defining an internal flow channel extending generally upwards from the lower end toward the upper end;
a first-stage filter element disposed toward or in the lower end, the first-stage filter element including a first filter media of relatively coarser porosity; and
a second-stage filter element disposed toward or in the upper end and generally upward of the first-stage filter element, the second-stage filter element including a second filter media of relatively finer porosity.

2. The two-stage oil separator of claim 1, wherein the second-stage filter element is vertically aligned over the first-stage filter element.

3. The two-stage oil separator of claim 2, wherein the first filter media comprises a metal wire mesh and the second filter media comprises a co-knit fiberglass and metal wire mesh.

4. The two-stage oil separator of claim 1, wherein the housing includes an elbow portion associated with the lower end and mounted horizontally to the crankcase and bending generally upwards to an upright portion associated with the upper end.

5. The two-stage oil separator of claim 4, wherein the internal flow channel has a generally circular cross-section at least through the upright portion.

6. The two-stage oil separator of claim 5, wherein the first-stage filter element and the second-stage filter element have a circular puck-like shape.

7. The two-stage oil separator of claim 6, wherein the first-stage filter element and the second-stage filter element have generally the same cross-sectional dimension.

8. The two-stage oil separator of claim 1, further comprising an ejector communicating with the upper end of the housing generally above the second-stage filter element for drawing crankcase gasses through the first-stage filter element and second-stage filter element.

9. The two-stage oil separator of claim 1, further comprising a cover disposed atop of the upper end of the housing, the cover including a latch mechanism for releasably securing the cover to the housing.

10. A method of ventilating crankcase gasses from a crankcase comprising:
providing a housing including a lower end and an upper end, the lower end communicating with the crankcase and the upper end communicating with an exhaust system, the housing defining at least in part an internal flow channel directed generally upward;
directing the crankcase gasses from the crankcase to a first-stage filter element disposed toward or in the lower end of the housing;
separating from the crankcase gasses with the first-stage filter element relatively larger droplets of oil;
directing the crankcase gasses generally upwards through the generally upward flow channel to a second-stage filter element disposed toward or in the upper end of the housing;
filtering from the crankcase gasses with the second-stage filter element relatively smaller oil droplets.

11. The method of claim 10, wherein the first-stage filter element includes a first filter media of relatively coarser porosity and the second-stage filter element includes a second filter media of relatively finer porosity.

12. The method of claim 11, wherein the first filter media is a metal wire mesh and the second filter media is a co-knit fiberglass and metal wire mesh.

13. The method of claim 12, wherein the crankcase gasses enter the lower end of the housing from the crankcase generally horizontally.

14. The method of claim 13, wherein the crankcase gasses are directed generally upwardly prior to entering the first-stage filter element.

15. The method of claim 10, further comprising drawing the crankcase gasses to the upper end of the housing by communicating an ejector with the upper end to generate a Venturi effect.

16. The method of claim 15, further comprising supplying the ejector with a motive fluid from a turbo.

17. The method of claim 10, further comprising coalescing the relatively larger droplets of oil in the first-stage filter element and returning coalesced oil to the crankcase by gravity.

18. The method of claim 10, wherein the second-stage filter element also filters blow-by particulates from the crankcase gasses.

19. The method of claim 10, wherein the internal flow channel has a generally circular cross-section.

20. An internal combustion engine comprising:
a crankcase having disposed therein a rotating crankshaft defining a horizontal axis of rotation;
a first two-stage oil separator including a housing, the housing communicating with the crankcase via a lower end and communicating with an exhaust system of the internal combustion engine via an upper end, the first two-stage oil separator further including a first-stage filter element disposed toward or in the lower end and a second-stage filter element disposed toward or in the upper end vertically above the first-stage filter element; and
a second two-stage oil separator including a housing, the housing communicating with the crankcase via a lower end and communicating with the exhaust system via an upper end, the second two-stage oil separator further including a first-stage filter element disposed toward or in the lower end and a second-stage filter element disposed toward or in the upper end vertically above the first-stage filter element;
wherein the first two-stage oil separator and the second two-stage oil separator are radially offset from each other with respect to the horizontal axis of rotation.
